(19) United States
(12) Patent Application Publication
(10) Pub. No.: US 2015/0299002 A1
(43) Pub. Date: Oct. 22, 2015

(54) ACTIVE CARBON FILTER SYSTEM AND METHOD

(71) Applicant: Purewater Medical, Inc, Longmont, CO (US)

(72) Inventors: Mark Forrest Smith, Longmont, CO (US); W. Mark Davis, Louisville, CO (US); Justin Charles Smith, Broomfield, CO (US)

(73) Assignee: Purewater Medical, Inc

(21) Appl. No.: 14/691,807

(22) Filed: Apr. 21, 2015

Related U.S. Application Data
(60) Provisional application No. 61/982,495, filed on Apr. 22, 2014.

(51) Int. Cl. C02F 1/469

(52) U.S. Cl. CPC C02F 1/4695; C02F 2201/46

(57) ABSTRACT

Activated carbon filter (ACF) system and method are disclosed. An example of the ACF system includes a plurality of activated carbon electrodes, The ACF system includes at least one current spreader for each of the plurality of activated carbon electrodes. The ACF system includes an electrical connection to provide electrical power to the plurality of activated carbon electrodes via the at least one current spreader. The ACF system includes an inlet and an outlet configured to provide fluid through a flow path in the plurality of activated carbon electrodes to remove contaminant from the fluid. The ACE system actively deionizes and removes chemical, biological, and/or other particles from a fluid (e.g., tap water).

### CROSS REFERENCE TO RELATED APPLICATION

This application claims the priority benefit of U.S. Provisional Patent Application No. 61/982,495 filed Apr. 22, 2014 for “Active Carbon Filter System,” hereby incorporated by reference in its entirety as though fully set forth herein.

### BACKGROUND

Home hemodialysis is an emerging sub-market in the hemodialysis market. New small machines are being developed by a number of hemodialysis equipment manufactures. These new dialysis machines are small and compact. Each of the new machines attempts to solve the generation of water for dialysis. One machine uses a batch method which takes approximately 7 to 8 hours to generate enough water for a treatment. Another machine uses a combination of reverse osmosis (RO) and thermal pasteurization. Yet another machine is incorporating a sorbent technology to remove the ions and biological load. Each of these methods uses a common core of hemodialysis, but different water purification methods.

The traditional method for water purification is reverse osmosis. Large industrial RO systems are incorporated in dialysis clinics all over the world. RO systems are expensive, require regular maintenance and are difficult to scale to a single user system in dialysis.

### BRIEF DESCRIPTION OF THE DRAWINGS

FIG. 1 is a cross-sectional view of an example activated carbon electrode stack assembly.

FIG. 2 shows a cross-sectional view of an example electrode assembly.

FIG. 3A shows an exploded cross-sectional view of an example electrode assembly. FIG. 3B shows a top view of the example electrode assembly in FIG. 3A.

FIGS. 4A-B show an example Block Activated Carbon disc, wherein FIG. 4A is a side view, and FIG. 4B is a top view. In another example, the layers are carbon cloth discs.

FIGS. 5A-B show an example ACC disc, wherein FIG. 3A is a side view, and FIG. 3B is a top view.

FIG. 6 shows an example electrode with current spreading pins.

FIG. 7 shows an example single tab perforated current spreader,

FIG. 8 shows an example dual tab perforated current spreader.

FIG. 9 shows an example quad tab perforated current spreader.

FIG. 10A shows an example heater current spreader.

FIG. 10B shows another example heater current spreader.

FIG. 11A shows an example split design heater current spreader.

FIG. 118 shows the example spreader circuit with electrical connections.

FIG. 12 illustrates an example electrical circuit 1200 of an electrode.

### DETAILED DESCRIPTION

An Active Carbon Filter (ACF) system is disclosed as it may be used to filter Primary Drinking Water, The Environmental Protection Agency (EPA) defines Primary Drinking Water according to the National Primary Drinking Water Regulations, as suitable for human consumption. While EPA Primary Drinking Water (often referred to as “tap” water) is suitable for human consumption, this water has not been sufficiently purified to meet the standards for medical use, as it may still contain chemical and/or biological contaminants.

The active carbon filter is based on the principle of flow through capacitive deionization. Activated Carbon (AC) is used to filter fluids due to its adsorptive and catalytic properties (Van der Waals forces). When carbon is activated, the carbon becomes very porous and increases the Specific Surface Area (SSA) to between 500 to 3000 m²/gram. AC increased SSA creates numerous attraction sites for chemical contaminants to attach via Van der Waal forces. AC is an efficient electrode as implemented herein for capacitive deionization, due to the high surface area and its ability to produce a strong double-layer capacitor.

A capacitive deionization cell can be produced by forming a gap between two electrodes through which water flows. When an electric potential is placed across the electrodes, an electric field is created and respective charge is gathered on the surface of the electrodes. As an oppositely-charged ion traverses the electrode, an electromotive force is applied to the ion which causes the ion to attach to the electrode surface. After the ion arrives at the surface, the electromotive force field and (to a lesser degree) Van der Waals forces hold the ion on the surface of the electrode. The electric force field is a lot larger than the Van der Waals force. Therefore, a capacitive deionization cell can collect more ions than passive activated carbon.

The example ACF disclosed herein includes a new capacitive deionization cell configured to utilize a flow through electrode design instead of a flow between electrode designs. The example ACF system includes activated carbon, for example, in granular, block, fabric, and/or cloth form. The ACF system actively deionizes and removes chemical and biological particles from tap water so as to generate pure solutions for medical applications. An example ACF system may be used by the hemodialysis market, and due to its size and relative ease of use, can be readily used for at-home hemodialysis. It is noted, however, that the ACF filter system is not limited to any particular end-use, and other implementations are also contemplated.

Before continuing, it is noted that as used herein, the terms “includes” and “including” mean, but is not limited to, “includes” or “including” and “includes at least” or “including at least.” The term “based on” means “based on” and “based at least in part on.”

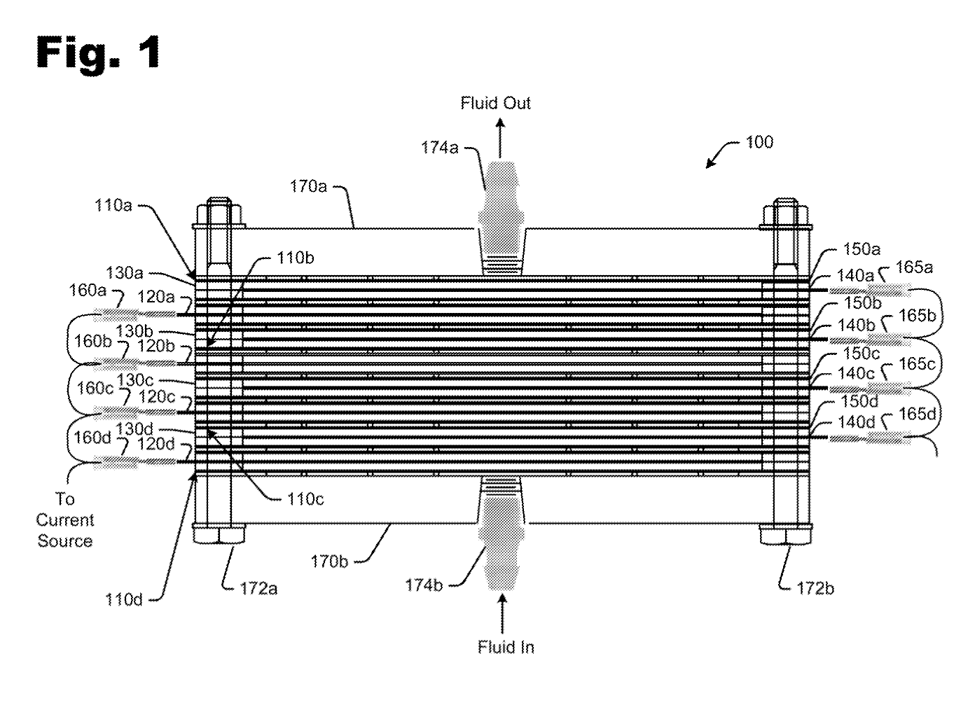

FIG. 1 is a cross-sectional view of an example activated carbon electrode stack assembly 100. The electrode stack assembly 100 may comprise a plurality of individual electrode assemblies arranged in layers 110a-d. For each layer 110a-d, the electrode stack assembly 100 may also include a current spreader 120a-d; a gap spacer 130a-d (e.g., a porous, electrically isolative material): a fluid seal 140a-d on the outer perimeter of each layer; a gap spacer gasket 150a-d, and connections (e.g., positive terminals 160a-d and negative terminals 165a-d) to provide electrical current from a source (not shown) to the current spreader 120a-d on each layer 110a-d.

An example electrode stack assembly 100 is comprised of a top and bottom end cap 170a-b, threaded rod or bolts 172a-b to hold the end caps 170a-b against the electrode stack(s) and provide clamping force for any number of layers 110a-d. The number of layers 110a-d may be determined by the incoming fluid electrical conductivity, fluid temperature, required ion rejection ratio, purification volume, and flow rate.

In an example, the end caps 170a-b have fluid distribution channels to distribute and collect fluid at the endcap. The channels are designed to slope to the entrance or exit port so as to easily remove air bubbles. In addition the end caps have sealing surfaces for the gaskets,

In an example, the end caps 170a-b seal the top and bottom of the electrode stack. The end caps 170a-b may also include ports 174a-b where fluid either enters or exits, The end cap 170a-b may also include bolt holes for clamping the electrode stack. The clamping mechanism (e.g., threaded rods or bolts 172a-b), when tightened provide a force to compress flange gaskets and optional spacer gaskets to seal the outside perimeter of the electrode assembly 100.

Because the electrodes are porous in all dimensions and fluid flows through the electrode, seals are made on the perimeter of the electrodes and on the top and bottom end caps 170a-b. The seals may be implemented as compression seals resulting from compression of elastomeric gaskets. To clamp the gaskets to make the fluid seals, a clamping mechanism may be employed. An example clamping mechanism includes stainless steel 18-8 bolts or threaded rod 172a-b. Although only two bolts 172a-b are shown in FIG. 1, an example bolt pattern may include any number of bolts (e.g., eight bolts for ¼-20 bolts). The nuts are tightened down to produce approximately 15 to 20% compression of the flange and spacer gasket.

An ACF system may include one or more electrode stack assemblies 100. The number of electrode stack assemblies 100 is determined by a number of factors, such as but not limited to, incoming fluid electrical conductivity, fluid flow rate, fluid average temperature, purification volume before regeneration, ion rejection and electrode assembly surface area. An electrode stack assembly 100 is comprised of two or more electrode assemblies and a fluid electrical conductivity sensor. A fluid electrical conductivity sensor may be positioned at the exit port 174a.

A fluid conductivity sensor (not shown) may be provided to determine the effectiveness of the electrode stack assembly 100. By knowing the exit conductivity, a system controller may be implemented to adjust the stack voltage to increase ion collection. In addition, the information from the conductivity sensor may be processed to determine the quality of ion collection of the electrode stack assembly 100 or the remaining capacity of the electrode stack assembly 100.

In an example, an electrode stack assembly 100 is configured with three electrodes. The outer electrodes are held at zero potential and the center potential is driven with an Alternating Current (AC) excitation. The outside electrodes shield the center excitation electrodes. Two gaps are formed similar to an ACC electrode assembly. One gap is between the lower and mid electrode and the other gap is formed between the mid electrode and the upper electrode. A polyester mesh may be provided to form the gaps. Gap width scales the gap resistance to a useful value signal conditioner circuitry. By using activated carbon for the electrode material with a high specific surface area, the polarization effect is greatly reduced.

An ACF system may have one or more connections to a power supply. A connection to a power supply may provide the electrical power to the electrodes. The connection may also provide a power supply for heating.

In an example, four connections are provided. The electrical conductivity decreases as the fluid flows through the stacks and the voltage and current are different for each stack. Therefore, multiple connections to power supplies may be provided. In addition the electrode power supply may include a switching network so as to change the electrode electrical connections from deionization to heating. There are several methods to drive electrodes, for example, by providing a constant voltage and/or constant current. Power conditioning circuitry may also be provided.

In an example, a constant voltage (e.g., between about 0.5 to 6.0V) is provided to drive an electrode stack. When a constant voltage is applied to an electrode stack, the current exponentially decays to a steady state voltage. In addition, a constant current electrode drive causes the voltage to be maintained to support the current. Deionization rate is proportional to the differential voltage across the electrodes. Thus, a constant current drive achieves low conductivity faster.

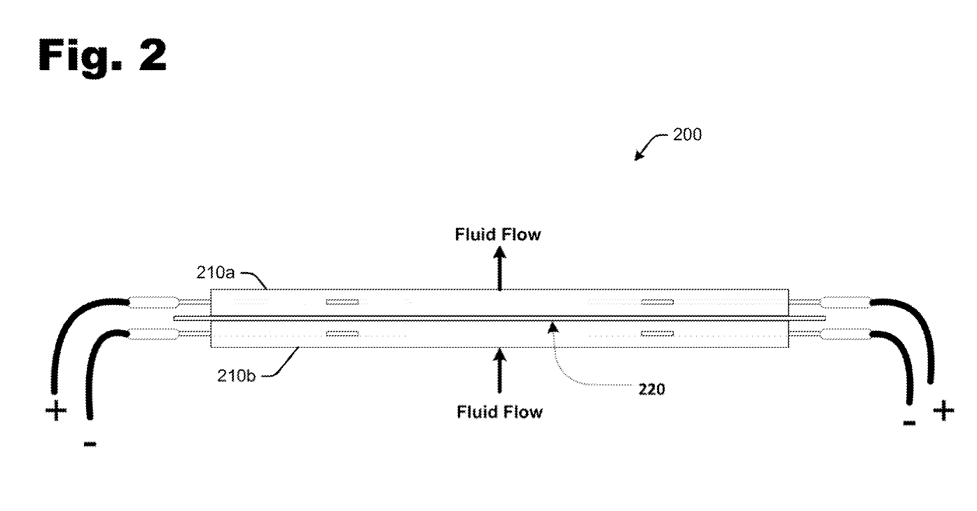

FIG. 2 shows a cross-sectional view of an example electrode assembly 200. This electrode assembly 200 (e.g., one of the layers 110a-d in FIG. 1) may be implemented with Block Activated Carbon (BAC). In an example, the electrode assembly 200 includes a first BAC electrode 210a and a second BAC electrode 210b. A gap 220 may be provided between the two electrodes 210a-b.

The gap between the electrodes sets up an electric force field. On one side of the gap 220 an electrode (e.g., 210a) is charged with a positive charge, and on the other side of the gap 220 an electrode (e.g., 210b) is charged with a negative charge, thus forming an electric force field. To maintain separation between the two electrodes, prevent electrical shorts, and allow fluid to flow freely through each electrode, a porous gap spacer is provided. A smaller gap 220 results in a larger electric force field and greater ability to capture ions on the respective electrodes. On the other hand, a smaller gap also results in lower electrical resistance of the fluid and higher current. Therefore, a porous gap spacer between the individual electrode assemblies may provide the proper thickness to operate at desired performance.

BAC is made from monolith material and the activated carbon is held together via a polymer. As such, the electrical short effect caused by small carbon particles is minimized. The gap 220 can be provided by a material such as a nylon or polyester disc of mesh material. An example system may implement SEFAR NITEX 06-310/45 (nylon). This mesh has an opening of 310 μm with a thickness of 250 μm and is 45 percent open. Therefore, the gap distance is 250 μm. In an example, the mesh extends past the BAC disc so as to reduce any edge effects. When electrode assemblies are assembled into a stack, the top and bottom of the stack are clamped so as to provide a clamping force to maintain uniform gaps created by the mesh.

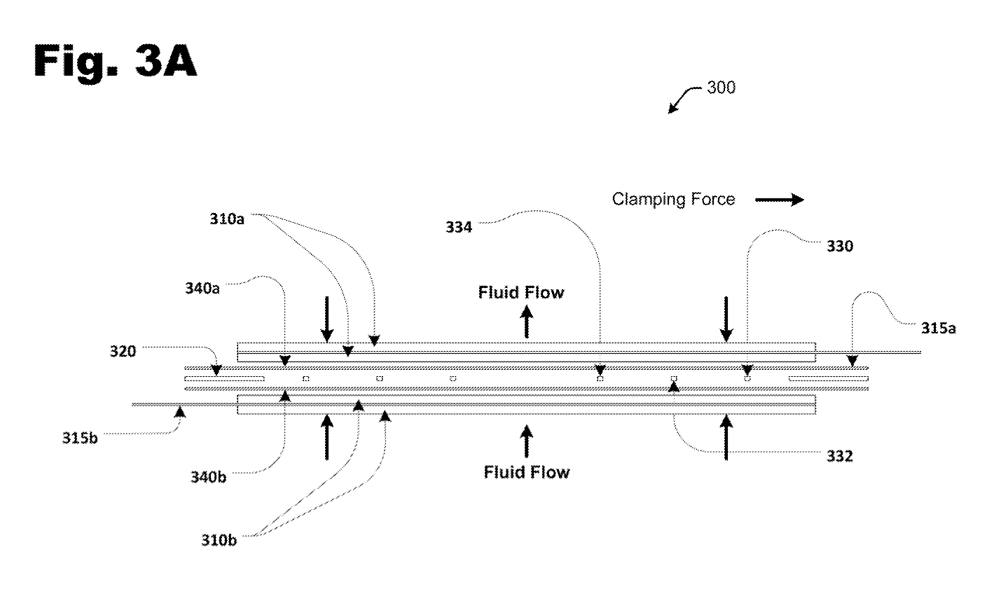

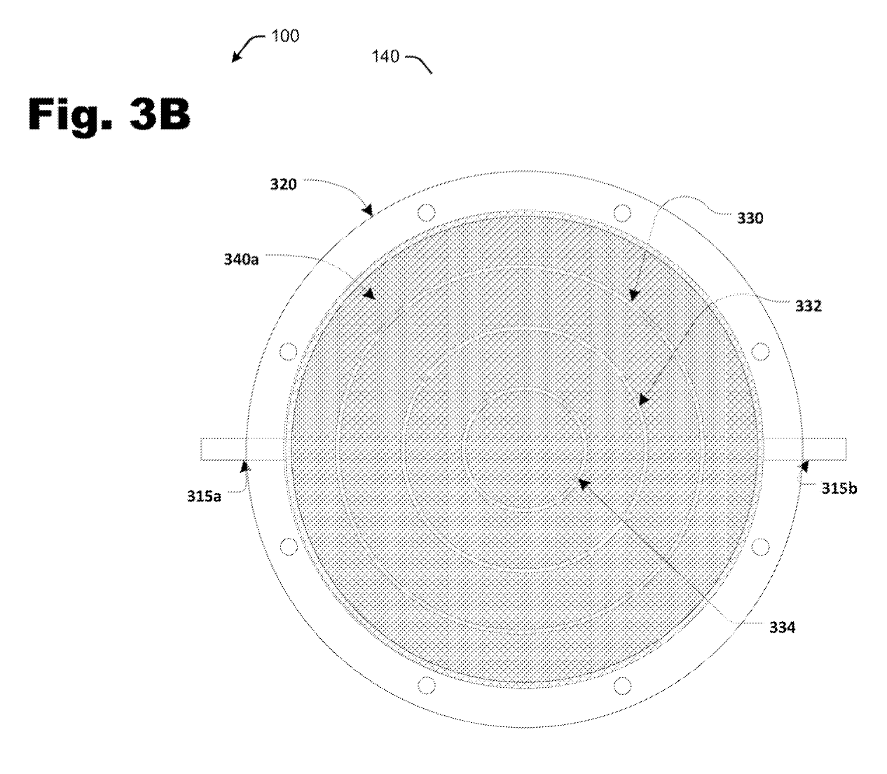

FIG. 3A shows an exploded cross sectional view of an example electrode assembly 300. FIG. 3B shows a top view of the example electrode assembly 300 in FIG. 3A. This electrode assembly 300 (e.g., one of the layers 110a-d in FIG. 1) may be implemented with activated carbon cloth (ACC). In an example, the electrode assembly 300 includes a first electrode 310a and a second electrode 310b, with first tab 315a and second tab 315b, and a gap spacer gasket 320.

Activated Carbon Cloth is made from very fine fibers (e.g., 7 μm in diameter). Due to the fine fibers of ACC, the gapping is implemented different than that of BAC. In addition, to reduce the contact electrical resistance between the ACC and the perforated current spreader, force is applied to the ACC to improve the contact surface area between the ACC and the perforated current spreader. To maintain a nearly constant force on the ACC, in an example, three elastomer compression rings are placed between the polyester mesh assemblies. The compression rings may include an outer compression ring 330, a middle compression ring 332, and an inner compression ring 334.

In an example, dual mesh (first mesh 340a and second mesh 340b) reduce or eliminate electrical shorts caused by ACC fibers. The compression rings 330, 332, and 334 maintain force on the ACC to reduce electrical contact resistance between ACC and the current spreader, A gap spacer gasket 320 sets the gap and prevents un-deionized fluid blow-by.

In an example, the gap spacer gasket 320 provides spacing between the two electrodes 310a-b and prevents un-deionized fluid from progressing to the next electrode. In an example, the gap spacer gasket 320 has a slightly smaller inside diameter (e.g., about 7.547″) so as to prevent a free fluid flow path on the outside diameter of the electrode. In an example, the thickness of the gap spacer gasket 320 may be about 1/64″ or 1/32″, depending upon the desired gap. The polyester mesh material 340a-b is located on either side of the gap spacer gasket. The gap spacer gasket 320 may be made from an elastomer material, such as Nitrile or a Thermal Plastic Elastomer (TPE). This material has a hardness between about 40 and 55 Shore A. As such, the gap spacer gasket 320 can compress to form a water seal.

In an example, the compression rings 330, 332, and 334 are placed between the polyester mesh 340a-b. The compression rings 330, 332, and 334 provide spacing of the polyester mesh and compress against the current spreader. In an example, only three compression rings 330, 332, and 334 are used to minimize the lost ion collection surface area, However, any number of compression rings may be implemented. Compression ring material can be the same as the gap spacer material, both thickness and hardness.

In an example, the mesh 340a-b provides electrical insulation between the electrode 310a-b. Both the square opening of the mesh 340a-b and the thickness of the mesh 340a-b must be small enough to restrict the AC from crossing the gap. By using two pieces of mesh separated by a ring spacer, the likelihood of the AC causing an electrical short has been minimized Currently, the mesh material is Polyester from SEFAR PETEX 07-100/32. This material has an opening of about 100 μm, a thickness of about 125 μm and an openness of about 32%.

In an example, the electrode assemblies may include porous activated carbon (AC) disc(s). The AC discs may be fabricated from a number of AC materials such as, Block Activated Carbon (BAC), Activated Carbon Cloth (ACC), Nonwoven ACC, and Granular Activated Carbon (GAC), Activated Carbon has a specific surface area (SSA) which ranges from 900 m²/gr to 2500 m²/gr. AC also has a surface density ranging from 50 gr/m² to 1000 gr/m², dependent upon material thickness. BAC tends to have a larger surface density and Nonwoven ACC the smallest surface density. Since an ACF stack is made up of multiple electrodes (e.g., two to several hundred), the porous activated carbon disc(s) may have porosity such that the maximum pressure drop across a stack is very small (e.g., less than about 1000 mmHg at flow rates of 1.0 liter per minute).

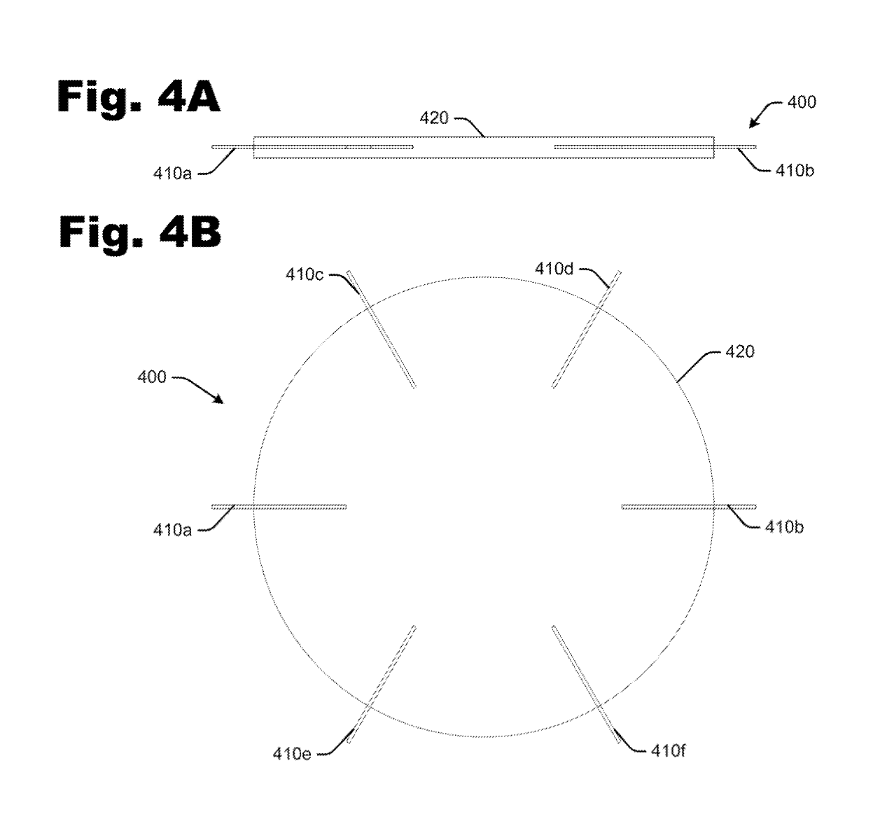

FIG. 4A-B show an example block activated carbon (BAC) disc 200, wherein FIG. 4A is a side view and FIG. 4B is a top view. The disc 400 may include current spreaders 410a-f (e.g. titanium or stainless steel 316 pins), and a disc portion 420.

The disc portion may comprise BAC manufactured from coconut shell granular activated carbon (SSA 1100 m²/gr) and a polymer. A mixture of the material is put in a mold and simultaneously heated and compressed to form a monolithic cylinder. The cylinder is sliced into thin discs. BAC material is porous and electrically conductive, thus suitable for a porous electrode design. The current BAC electrode design is 5.5″ diameter and 0.25″ thick and has a filter cutoff size 0.5 um.

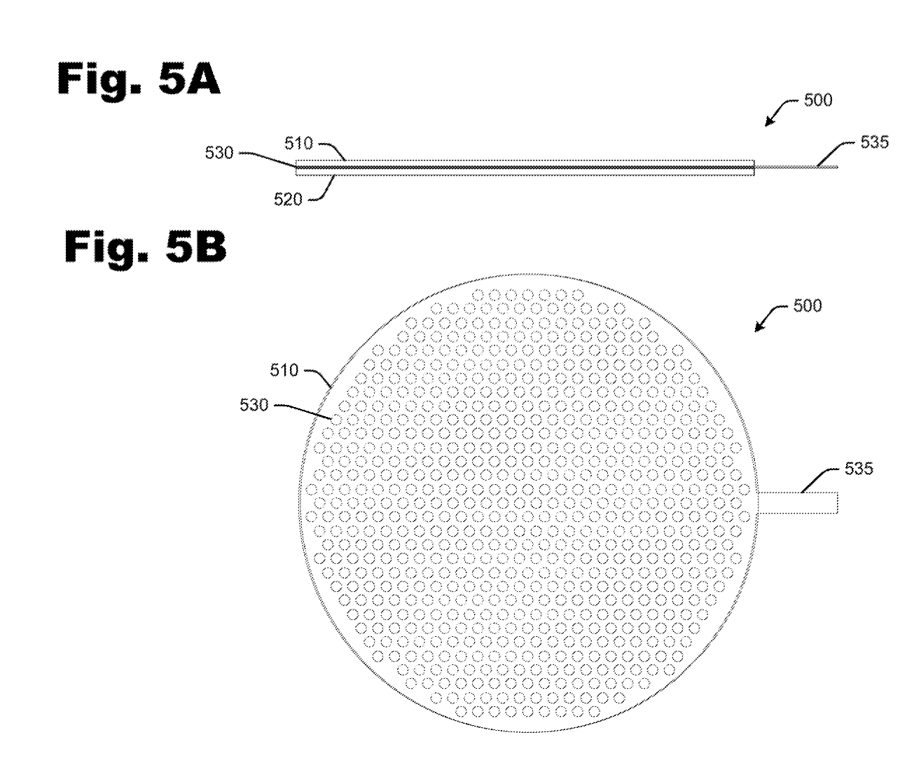

FIGS. 5A-B show an example activated carbon cloth (ACC) disc 500, wherein FIG. 5A is a side view and FIG. 5B is a top view The disc 500 may include a first (e.g., top) ACC 510 and a second (e.g., bottom) ACC 520. A current spreader 530 (e.g., titanium or stainless steel 316 perforated disc) may be provided between the top ACC 510 and bottom ACC 320. Electrical connection tab 535 may connect to the current spreader 530.

The disc portion 500 may comprise ACC as an electrode material. ACC material may be provided as single weave, double weave, and knit. In addition the material can be provided in different thickness ranging from 0.20 mm to 1.0 mm. ACC may be manufactured of several different precursor materials such as Rayon, Phenolic, Kynol, and Viscose. Each material and activation method results in different Specific Surface Area (SSA) ranging between 500 m²/gr and 2500 m²/gr. ACC comes in large rolls and must be cut into discs. An example ACC electrode design is 7.65″ diameter and 1.0 mm thick. The ACC material is very porous Table 1 is a list of ACC commercially available material.

TABLE 1

| | | | | | SSA | Surface |
|---|---|---|---|---|---|---|
| Part Number | Vendor | Thickness | Weave | Precursor | (BET) | Density |
| Zorflex FM100 | Chemviron | 1.0 mm | Double | Viscose - | 1100 m²/gr | 220 gr/m² |
| | | | | Rayon | | |
| Zorflex FM10 | Chemviron | 0.5 mm | Single | Viscose - | 1100 m²/gr | 120 gr/m² |
| | | | | Rayon | | |
| ACC 507-15 | Gunei | 0.5 mm | | Kynol | 1200 m²/gr | 120 gr/m² |
| | Chemical | | | | | |
| ACC 5092-20 | Gunei | 0.5 mm | | Kynol | 1600 m²/gr | 136 gr/m² |
| | Chemical | | | | | |
| Spectracarb | Spectra Corp | 0.5 mm | | Phenolic | 2500 m²/gr | 135 gr/m² |
| 2225 | | | | | | |

Although not illustrated, other examples of material suitable for the layers 110a-d of the electrode assembly 100 shown in FIG. 1 include, but are not limited to, nonwoven, activated carbon felt (ACF) and granular activated carbon (GAC).

The current spreader reduces radial voltage gradient across the porous activated carbon electrode. Due to porosity and activation of the carbon in the electrode, the activated carbon has a much higher bulk resistivity than any typical metal. In addition, when the electrode is pulling high levels of ions out of the fluid, a high current is needed, and thus a low resistance electrical connection to the activated carbon may be provided to reduce the voltage gradient radially across the electrode. In addition, the current spreader may be configured to turn an electrode into a heating element.

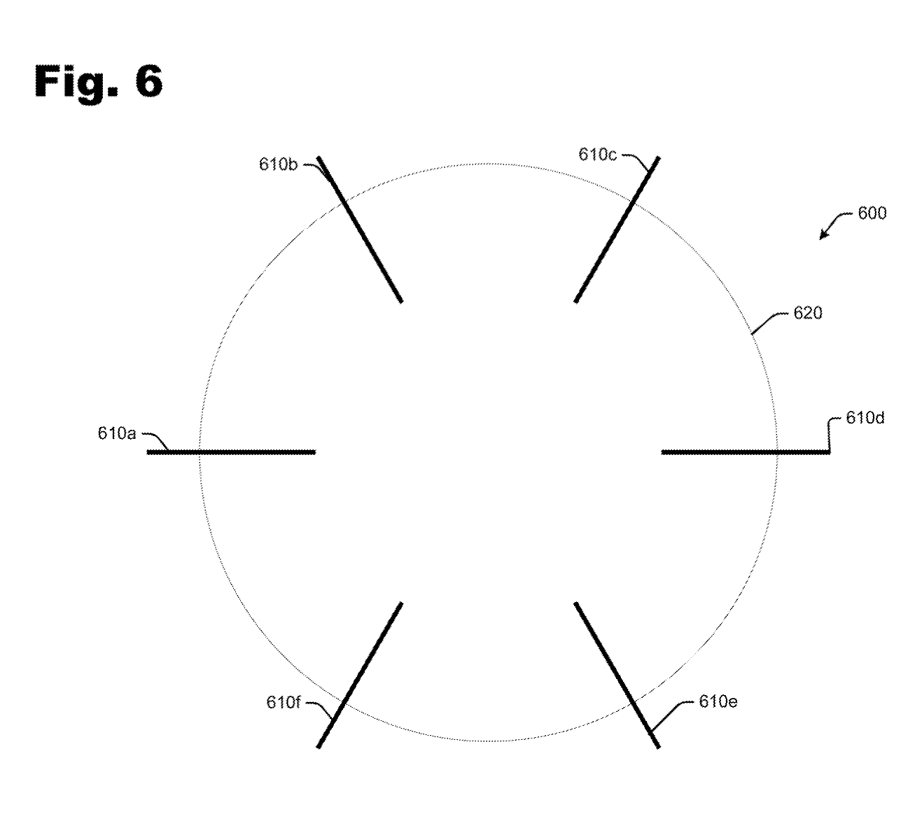

FIG. 6 shows an example electrode 600 with current spreading pins 610a-f. An example electrical connection to the electrode 400 may be provided by making holes (e.g., 0.040″ to 0.0625″) around the perimeter of the disc 620. The holes may be smaller than the wire pin so as to make a very tight press fit, thus resulting in a low ohmic electrical contact. An electrical pin connector is place on the end of the pin 610a-f sticking out of the disc 620 so as to make wire connection to the electrode drive power supply.

The pin material may be a low corrosive metal such as Titanium or Stainless Steel 316/316L, in an example, a small diameter Titanium pin may be provided as the current connector in the AC. To connect to the small diameter pin, an off-the-shelf socket connector may be provided, such as a 24 AWG wire crimped to the connector and other end connected to the electrode driver circuit or power supply. The socket connector forms a mechanical compression connection to the Titanium.

Thus, the use of multiple pins enables a low electrical contact resistance to the electrode. The number of pins 610a-f can vary with respect to the diameter of the disc 620 and/or the length of the pins 610a-f. In an example, the number of pins relate to the contact resistance as illustrated in Table 2. It can be seen that in this illustration, the change in resistance after six pins becomes very small, diminishing returns, with respect to the absolute contact resistance.

TABLE 2

| Number | Contact |
|---|---|
| of Pins | Resistance (Ohms) |
| 1 | 10.00 |
| 2 | 5.00 |
| 3 | 3.33 |
| 4 | 2.50 |
| 5 | 2.00 |
| 6 | 1.67 |
| 7 | 1.43 |
| 8 | 1.25 |
| 9 | 1.11 |
| 10 | 1.00 |

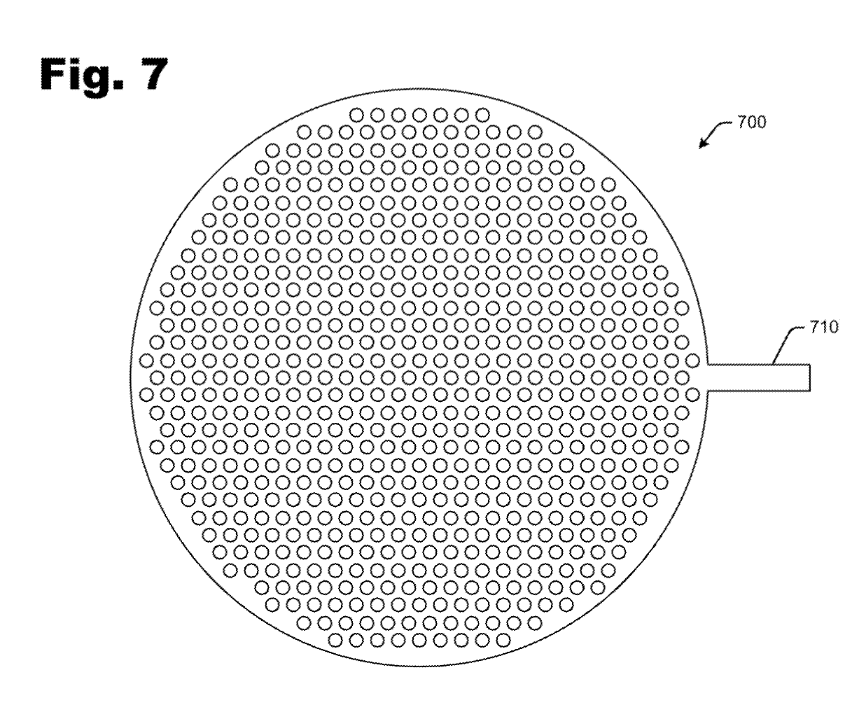

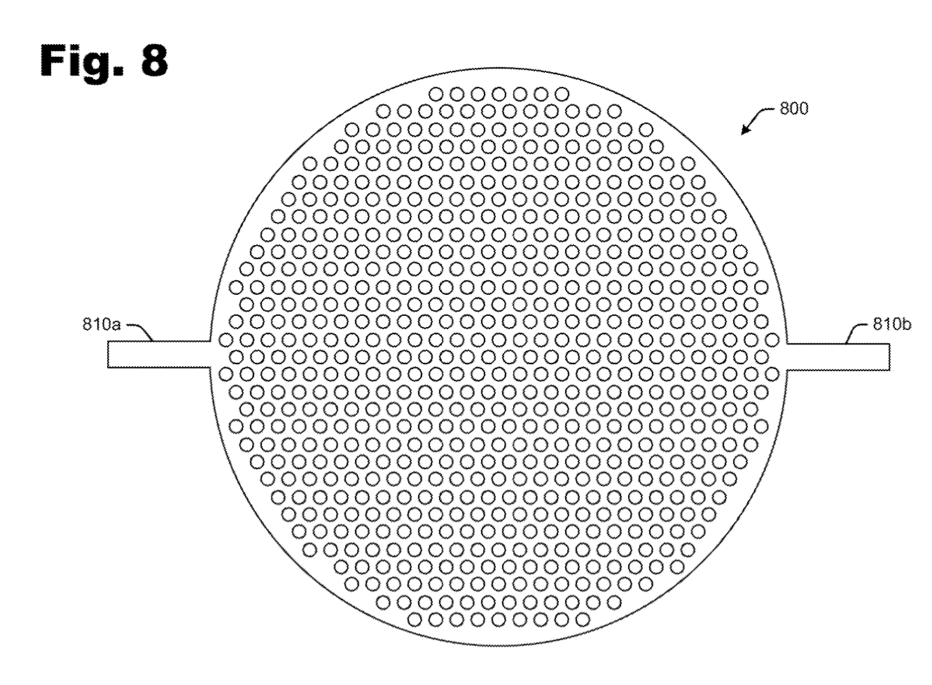

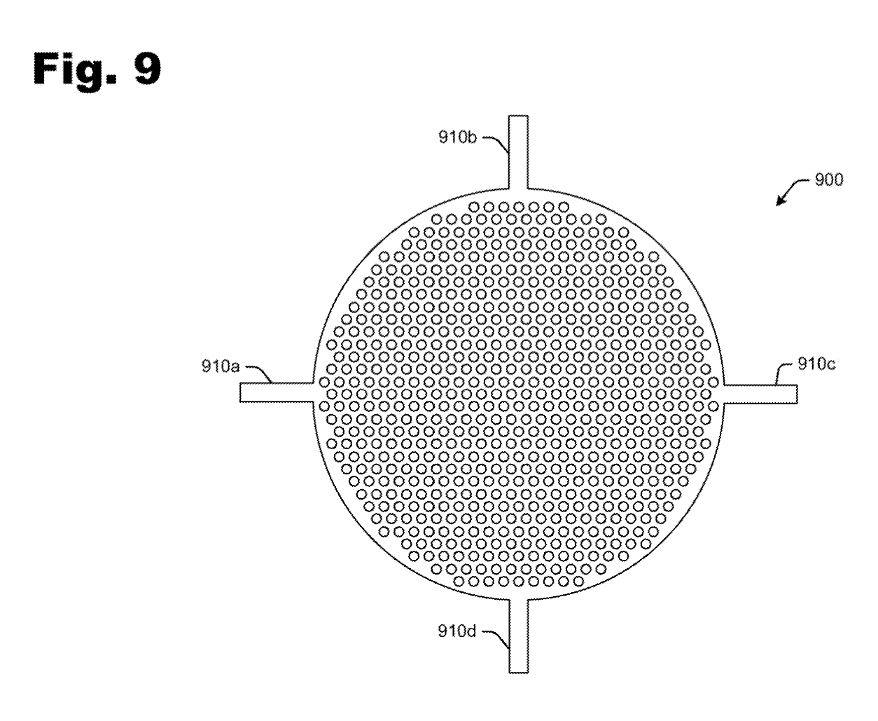

Another example current spreader is a perforated disc with electrical connection tab(s), for example, as illustrated in FIGS. 7-9. FIG. 7 shows an example single tab 710 perforated current spreader 700. FIG. 8 shows an example dual tab 820a-b perforated current spreader 800. FIG. 9 shows an example quad tab 900a-d perforated current spreader 900.

In these examples, a perforated disc enables fluid to flow unrestricted through the electrode assembly. An AC disc is positioned on either side of the perforated current spreader to make the electrode assembly (e.g., as illustrated in FIG. 1).

In an example, a force is applied to the AC disc to provide a low ohmic electrical contact. The force may be provided by elastomeric bands on either side of the electrode assembly. Narrow elastomeric bands may be placed on either side of the AC disc. When the electrode stack assembly is assembled, the end caps (see, e.g., FIG. 1) compress the elastic bands, thus forcing the AC onto the current spreader.

The perforated disc current spreader may be constructed with very low corrosive or inert metal such as Titanium or Stainless Steel 316/316L. In an example, the current spreader is about 7.95″ in diameter, 0.002 thick, and the material is Stainless Steel 316 (fully annealed) with approximately two thousand 0.125″ holes and two electrical connection tabs.

In an example, the perforated disc current spreader may have a diameter that is slightly larger than the electrode so as to seal on the gasket and prevent fluid from circumventing the electrodes. The hole size and the pattern of perforations may be set so as to make a good electrical contact. In addition to the hole size and pattern, the openness of the holes may be below about 50% so that enough current spreader material is left for good electrical contact. The holes may be recessed from the outside diameter so as to leave current spreader material to block blow by fluid. The current spreader may be sufficiently thin so as to conform to the AC disc when force is applied by the elastomeric rings. In an example, the material is about 0.002″ thick Stainless Steel 316 (fully annealed).

The tabs enable electrical connection to the current spreader while maintaining a fluid seal. One or more tabs are used to make electrical connection to the current spreader. In an example, the tabs may be folded over connector shims to provide the desired thickness for the quick disconnect connector, The number of tabs may be determined by the thickness of the material and the current requirements of the electrode. More tabs provide equivalent lower contact resistance. For electrode assemblies with high current requirements, the current spreader may have two or more electrical tabs so as to reduce the radial voltage gradient.

The ACF system is a low voltage device, and therefore operates with high currents (e.g., about 1 to 15 amperes) to remove large amounts of ions. Therefore, electrical connections may be low ohmic connections (e.g., less than about 0.02 Ohms). For the BAC current spreader, the contact resistance between the titanium pins and the carbon may be less than about 0.02 Ohms.

For the ACC current spreader, the contact resistance between the ACC and the current spreader may be less than about 0.02 Ohms. In an example, the ACC current spreader is constructed from 0.002″ or 0.004″ metal foil. The electrical connection is folded over onto itself with a thin (e.g., about 0.012 to 0.016″) connector shim material to make a thickness of 0.020″, With the tab being 0.020″ thick and 0.250″ wide, a 0.250″ quick disconnect connector can slide over the electrical connection tab and make a low resistivity electrical contact, The other end of the quick disconnect terminal is crimped onto a 24 AWG wire and then connected to the electrode driver circuit or power supply.

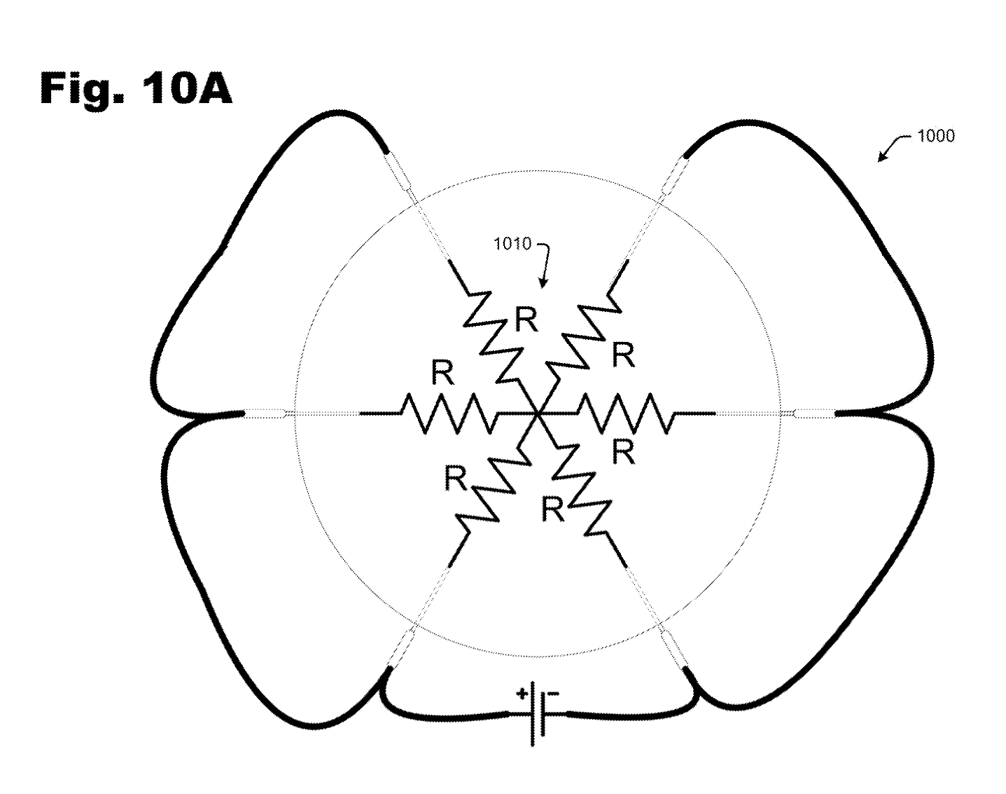

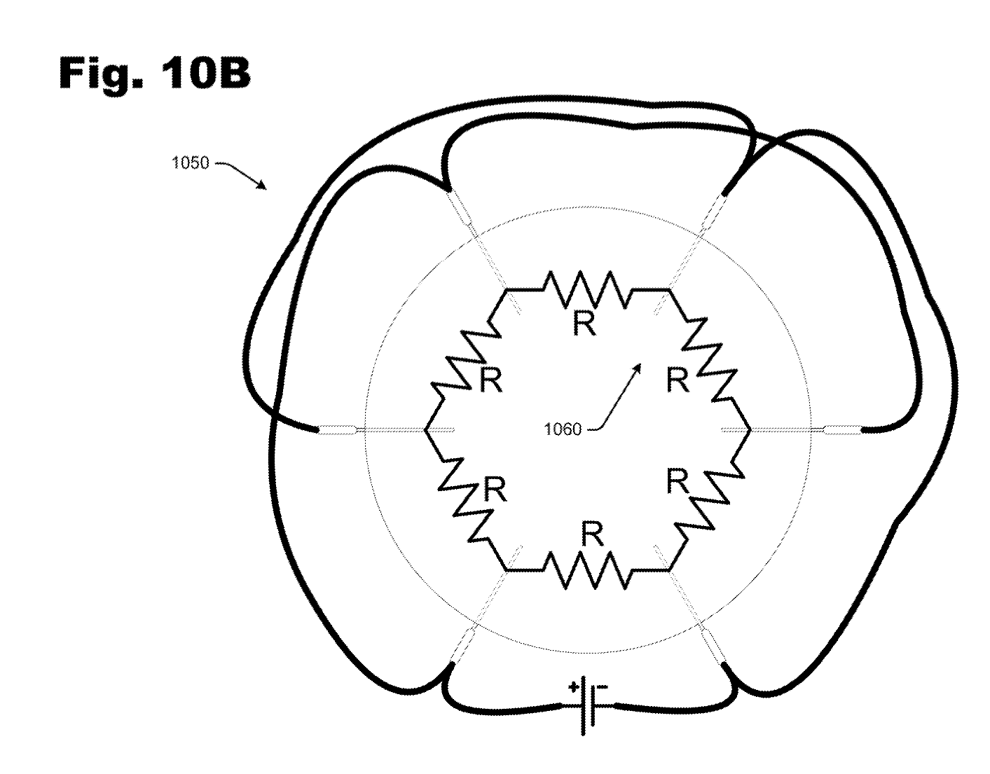

FIG. 10A shows an example heater current spreader 1000. FIG. 10B shows another example heater current spreader 1050. The flow-through design of the electrode assembly described herein enables heating of the fluid via the activated carbon. Activated carbon has very high specific surface area. As such, the electrode assembly may be implemented as a highly efficient heater,

To be able to use an electrode assembly as a resistive heating element, the current spreader can be configured to support heating, e.g., by a resistive network. Example resistive networks 1010 and 1060 are illustrated in FIGS. 8 and 9. In an example alternated voltage configuration, every other pin is positive and the pins in between are negative. In another example, one side of the current spreader is positive and the other side is negative. Of course, other circuits may also be implemented, as will be readily understood by those having ordinary skill in the art after becoming familiar with the teachings herein.

In an example pin current spreader, one-half of the current spreader connections are attached to one side of the heater power supply and the other half is attached to the other side of the power supply, The activated carbon between the pin electrode configurations forms a resistive heater. Thus, by applying voltage to the current spreader pins, electrical energy is converted to thermal energy. When water passes through the electrode assembly, thermal energy is transferred by conduction and convention to the fluid, thus raising the temperature of the fluid.

In an example deionization configuration, each electrode assembly is at a first potential. In the heater configuration, an electrode assembly current spreader is provided to support differential voltage across the current spreader. The electrical path for a heater electrode assembly may be provided through a portion or all of the AC material.

The heater current spreader designs enable a single current spreader to be implemented for both deionization and heating. When a single current spreader is used for deionization and heating, an electrode driver switching network (not shown) may be provided to apply the electrode driver voltage to the appropriate current spreader electrical connections.

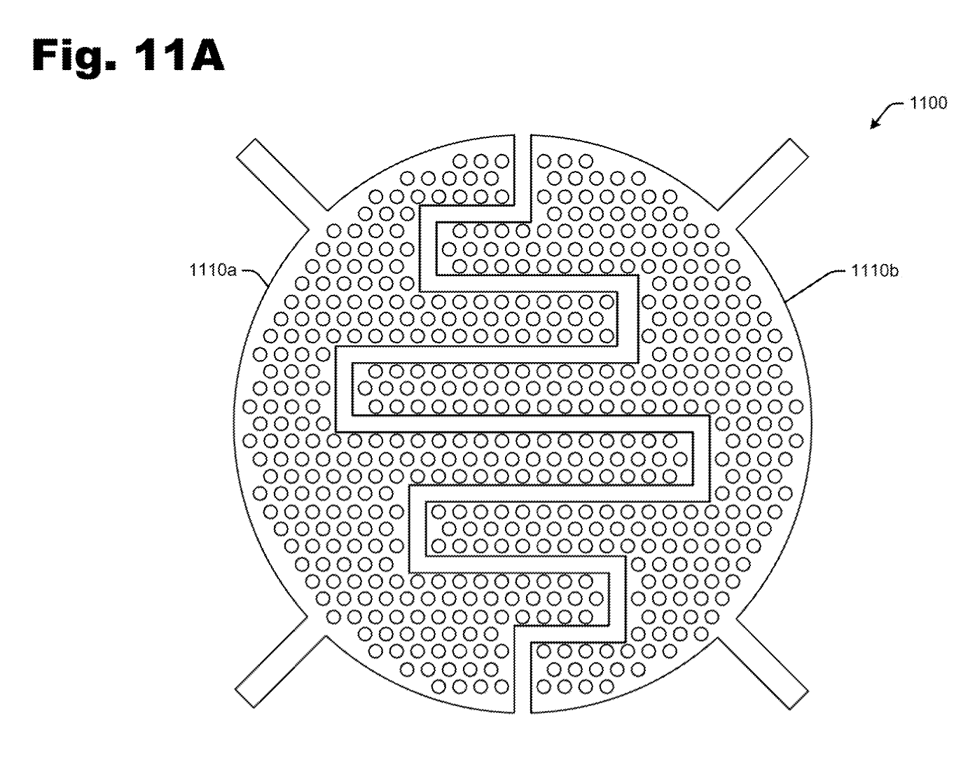

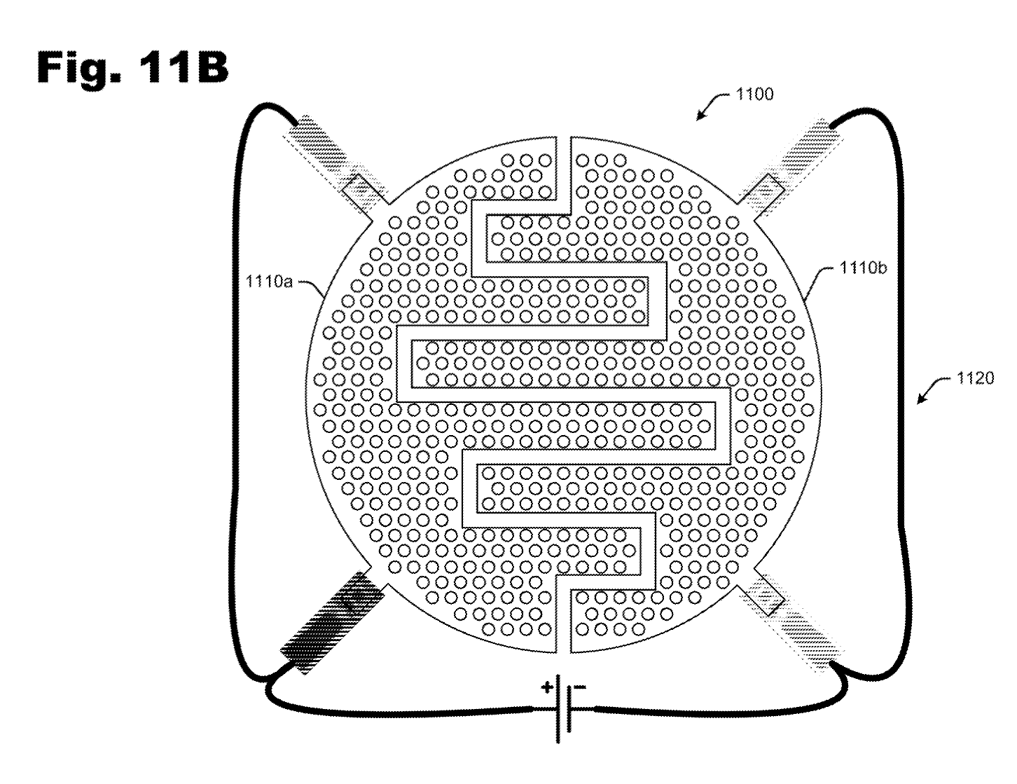

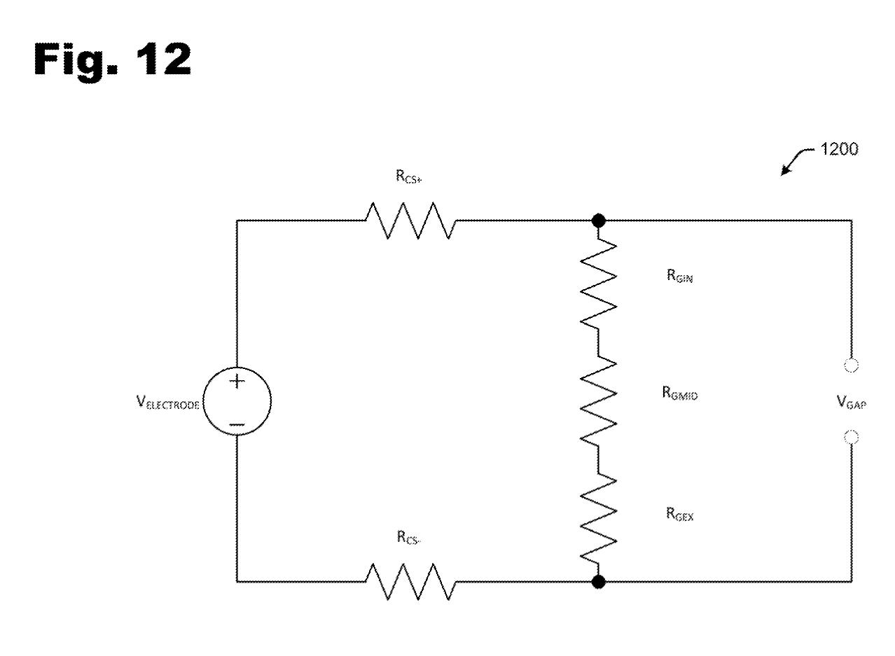

Another example current spreader is shown in FIGS. 11A-B. This current spreader 1100 enables an electrical resistive path to provide heating is a split configuration. In this example, the current spreader is split (e.g., into two halves 1110a-b with a predefined serpentine gap path). FIG. 11A shows an example split design heater current spreader 1100. FIG. 118 shows the example spreader circuit 1100 with electrical connections 1120. This configuration enables both deionization and heating in a single current spreader.

In an example, the current spreader has a gap width which is one or more circle patterns wide. The gap length is determined by the desired resistance of the heater. Since carbon is a good thermal conductor, the coverage of the heater gap need only be less than about 10% of the electrode assembly area. To reduce hot spots in the heater, two or more electrical connection tabs are used to keep the current density in the current spreader substantially uniform.

FIG. 12 illustrates an example electrical circuit 1200 of an electrode. In this example, R_{CS+} and R_{CS-} are the current spreader equivalent resistance, The current spreader resistance for the ACC electrode is between 2.5 and 6.0 ohms. V_{GAP} is the voltage across the fluid gap. V_{ELECTRODE} is the electrode power supply. RGIN, RGMID, and RGEX are the electrical equivalent of the electrical conductive fluid in the gap.

To collect charged particles on the electrodes, a differential voltage exists across the gap (V_{GAP}). In an example, this voltage may be in the range of about 1.00 Volts to about 2.00 Volts, Electrolysis begins at about 1.25 Volts. For optimum performance, V_{GAP} may be about equal to V_{ELECTRODE}. Since there are losses due to R_{CS+} and R_{CS-}, the gap resistance may be increased to a predetermined optimal value. An example consideration when optimizing the gap resistance is the gap distance, because the charge particle holding force is equal to the inverse of the gap distance. Therefore, increasing the gap distance increases the gap resistance, but at the same time reduces the holding force.

Creating a gap with porous material is an example technique to increase the gap resistance, while maintaining the gap distance. An example is to use a fine thin mesh with an openness of less than about 35% to restrict carbon whiskers from the ACC, and a mid-section coarser mesh with an openness of less than about 35% and an exit mesh identical to the entrance mesh. By having a polyester mesh fill up over about 65% of the space, the electrical resistance of the fluid is increased by nearly three times, thus increasing V_{GAP} without changing the gap distance. There is a limit to the openness of the gap material. The smaller the openness number, the higher the pressure drops. As such, there is a tradeoff between openness and high pressure.

Having a variable gap in a stack of electrode enables each electrode pair to be tuned for the incoming fluid conductivity for the pair. When high conductivity water (e.g., greater than about 250 us/cm) is the input, both the gap distance and the gap material may be optimized to increase the gap resistance to increase the gap voltage V_{GAP}. After the electrical conductivity of the fluid is reduced because of deionization, the gap can be reduced to maintain approximately the same voltage across the gap, thus optimizing the performance,

Increasing the gap resistance also reduces the current. As such, for the same voltage, if the gap distance does change, the electrode current drops. Therefore, the system becomes more electrically efficient. After building several ACF systems and building an analysis model, it has become apparent that the gap between the electrodes plays a big role in the efficiency of the system. This has become more apparent when the electrical model is reviewed.

When using Activated Carbon Cloth (ACC), a current spreader is used to reduce the voltage gradient across the ACC electrode. The electrical path for an electrode pair is defined as follows: positive current spreader, fluid gap, and negative current spreader. The current spreader electrical resistance can be broken down into its sub components; wire, crimp connector, metal current spreader, and ACC contact resistance. The gap electrical resistance can be broken down into three sections; entrance, mid, and exit. The electrical schematic shown in FIG. 12 illustrates the electrical circuit of the electrode circuit. Of course, the electrical circuit 1200 is merely illustrative and not intended to be limiting.

Before continuing, it should be noted that the examples described above are provided for purposes of illustration, and are not intended to be limiting. Other devices and/or device configurations may be utilized to carry out the operations described herein. By way of illustration, the AC is not limited to BAC or ACC. The AC disc is not limited to any size, shape, or other configuration. Other components may be implemented in addition to and/or substitution for the specific components shown and described herein, as will be readily apparent to those having ordinary skill in the art after becoming familiar with the teachings herein.

The electrode stack assembly ACF system described herein may be operated in a variety of modes. Example modes of operation include, but are not limited to, deionization, deionization with temperature control of output fluid, heat disinfection, regeneration, and pH control.

In deionization mode, input water is deionized to a level which may be used for medical application. In an example, maximum input water electrical conductivity is about 500 μS/cm, the maximum for EPA drinking water. The output water chemical contaminates are reduced to where the electrical conductivity is less than about 1.0 μS/cm. In this operational mode, the maximum ion rejection is greater than about 99.8 percent.

In deionization with temperature control mode, operation is the same as described above for deionization mode, but with a highly efficient flow through low voltage electrical heater on the output. A temperature sensor placed in line with the output enables the output water to be precisely controlled. For medical application, the water can be controlled to about 37.0±0.1° C. at a flow rate of about 800 mL/min, while maintaining deionization. Positioning the heater on the output of the deionizer is important because capacitive deionization is less effective at higher temperatures. Therefore, positioning the heater on the output provides the ability to increase temperature without compromising heater efficiency.

The heat disinfection mode enables disinfection of the ACF system, and even any system following the output. To disinfect the electrode stack, one or more activated carbon heater electrodes are formed into a heater stack and placed at the water input before the activated carbon electrode stack(s). The input water supply flow rate may be greatly reduced (e.g., to less than about 25 mL/min) and the heater turned on to a high power setting. By the combination of a low flow rate, highly efficient heat transfer from the activated carbon heater, and the high power setting, the input water is heated to over 80° C. As the water flows slowly through the activated carbon electrode stack(s), the stack(s) are heated to about 80° C. The output temperature sensor monitors the output temperature and times the duration of the output fluid being held above about 78° C. After a predetermined time, the input heater may be turned off and the flow rate increased to cool down the ACF system.

The pH control mode is an operating mode to control pH of the exiting fluid. To achieve pH control the electrode voltage is increased (e.g., above about 1.25 volts) to cause electrolysis. When electrolysis occurs, the pH drops. Thus, operation of the ACF system in the pH control mode enables control of the pH, e.g., in a range of about 4.0 to about 7.0.

In regeneration mode, the activated carbon electrode stack is regenerated by removing charged particles held on the electrodes by the electric field. To collect charged particles, an electric field is setup by an applied voltage across the electrode stack. Charged particles remain attached to the activated carbon electrode until the electric field is removed, Therefore, to flush charged particles off the electrodes, the electric field is removed and water is pumped through the electrodes. There are several methods to implement regeneration mode.

In an example, the regeneration mode may implement fluid flushing. This technique includes forcing fluid (e.g., water) through the electrode stack with little or no voltage applied to the electrodes. As fluid flows through the electrode stack, charged particles are released from the electrode and cause the fluid electrical conductivity to increase. After the electrical conductivity peaks, conductivity starts to exponentially decay to the electrical conductivity of the input fluid. The rate of decay is governed by a number of factors such as flow rate, temperature, driving charged particles off the electrode by reverse polarity, and incoming electrical conductivity.

In an example, the regeneration mode may implement flow rate control. According to this technique, the flow rate of the incoming fluid has lower electrical conductivity than the exiting fluid during regeneration. To decrease the regenerating time, a large concentration gradient is implemented to accelerate the diffusion process. Therefore, a high flow of low concentration fluid increases the diffusion process and reduces the regeneration time.

In an example, the regeneration mode may implement thermal regeneration. According to this technique, the temperature of the electrodes is increased to decrease the regeneration time. Diffusivity of a chemical increases with temperature. Therefore, increasing the temperature increases the diffusivity, thus reducing regeneration time. Therefore a unique feature of the ACF system is its ability to heat the electrodes by an electrical joule heating method. One or more inlet electrodes need only be heated as the fluid flows by the inlet heater. The increased temperature of the fluid flows by all the remaining electrodes and by convection, heats all the electrodes to increase the diffusivity of the charged particles falling off the electrodes,

In an example, the regeneration mode may implement a reverse flushing technique to decrease the regeneration time. According to this technique, the flow of the flushing fluid is reversed. Because the fluid exiting the ACF system is pure water, by reversing the flow, the high purity water moves to the inlet of the ACF, thus providing a high concentration gradient and increasing the diffusion process. The flow may be sufficiently slow to provide time for the charged particles to diffuse into the low concentration fluid.

In an example, the regeneration mode may implement a dwell time technique to remove the charged particles off of the electrodes once the voltage is removed. After the voltage is removed, the charged particles naturally drop off. After the dwell time (e.g., about 4 to 8 hours), water is pumped through the ACF System to flush the high concentration fluid.

In an example, the regeneration mode may implement electrode reverse polarity. According to this technique, the charged particles are driven off the electrodes by changing the polarity of the voltage on the electrodes. There are several techniques to implement electrode reverse polarity.

In an example, reverse polarity may be implemented according to a pulsed technique. This method implements very short voltage pulses (e.g., greater than 4 volts between about 1 μsec to 100 μsec). The duty cycle of the pulse may be set so as to flush the charged particle out of the gap.

In an example, reverse polarity may be implemented according to a synchronized sine wave technique. This method implements a sine wave voltage synchronized to the flow rate so as to not collect charged particles, while driving charge particles off the electrodes.

It is noted that the examples shown and described are provided for purposes of illustration and are not intended to be limiting. Still other examples are also contemplated.

1. An active carbon filter (ACF) system, comprising:
Porous, conductive activated carbon electrodes; and
a current spreader.

2. The ACF system of claim wherein activated carbon electrode is block activated carbon (BAC).

3. The ACF system of claim 1, wherein the activated carbon electrode is activated carbon cloth (ACC).

4. The ACF system of claim 1, wherein activated carbon of at least one of the activated carbon electrodes, is the primary electrode.

5. The ACF system of claim 1, further comprising a frame to maintain compression of the activated carbon electrodes and the current spreader.

6. The ACF system of claim 1, further comprising at least two electrical connections to the electrode assembly to heat at least one of the activated carbon electrodes.

7. The ACF system of claim 5, wherein the activated carbon electrodes are configured in parallel for flow-through operation.

8. The ACF system of claim 1, wherein at least one of the activated carbon electrodes are configured to capture charged particles including at least ions, molecules, bacteria, viruses, and endotoxins.

9. The ACF system of claim 1, wherein at least one of the activated carbon electrodes is configured for selective ionic, molecular and biological particle removal from water.

10. An active carbon filter (ACF) system, comprising:
a plurality of activated carbon electrodes;
at least one current spreader for each of the plurality of activated carbon electrodes;
an electrical connection to provide electrical power to the plurality of activated carbon electrodes via the at least one current spreader; and
an inlet and an outlet configured to provide fluid through a flow path in the plurality of activated carbon electrodes to remove contaminant from the fluid.

11. The ACF system of claim 10, further comprising a first end plate and a second end plate, the first end plate and the second end plate compressing the plurality of activated carbon electrodes therebetween.

12. The ACF system of claim 10, wherein each of the activated carbon electrodes has a gap spacer made of a porous, electrically nonconductive material.

13. The ACF system of claim 12, further comprising a gap spacers with varying physical properties throughout the plurality of activated carbon electrodes.

14. The ACF system of claim 10, further comprising a fluid seal on an outer perimeter of each of the plurality of activated carbon electrodes.

15. The ACF system of claim 10, further comprising an electrical connection to the current spreader to provide electrical current.

16. The ACF system of claim 10, further comprising a heater current spreader circuit.

17. The ACF system of claim 10, further comprising a split heater current spreader circuit.

18. A method of activated carbon filtration, comprising:
providing a plurality of activated carbon electrodes;
providing at least one current spreader for each of the plurality of activated carbon electrodes;
providing a connection to electrical power for the plurality of activated carbon electrodes via the at least one current spreader; and
providing a fluid-flow through path in the plurality of activated carbon electrodes to remove contaminant from the fluid.

19. The method of claim 18, further comprising operating in at least one of the following modes: deionization mode, deionization and temperature control mode, heating disinfection mode, heating regeneration mode, regeneration mode, and pH control mode.

20. The method of claim 18, further comprising both heating and deionizing a fluid in the fluid flow-through path via an electrical current provided to the at least one current spreader.
